(19) United States
(12) Patent Application Publication
(10) Pub. No.: US 2015/0375927 A1
(43) Pub. Date: Dec. 31, 2015

(54) FILTER UNIT FOR A CAPSULE AND CAPSULE COMPRISING SUCH FILTER UNIT

(71) Applicant: Nestec S.A., Vevey (CH)

(72) Inventors: Hans-Markus KOHLI, Montagny-près-Yverdon (CH); Sophie ABRAHAM, Remoray (FR); Heinz WYSS, Oberdiessbach (CH); Thierry Jean Robert FABOZZI, Geneve (CH); Nicolas Jean-Guy BEZET, Macon (FR)

(73) Assignee: Nestec S.A., Vevey (CH)

(21) Appl. No.: 14/760,785

(22) PCT Filed: Jan. 9, 2014
(86) PCT No.: PCT/EP2014/050260

§ 371 Date: Jul. 14, 2015

(30) Foreign Application Priority Data
Jan. 14, 2013 (EP) 13151119.8

(51) Int. Cl. B65D 85/804; B01D 27/00; B01D 27/08

(52) U.S. Cl. CPC B65D 85/8043; B01D 27/08; B01D 27/005

(57) ABSTRACT

A filter unit for a capsule for preparing a beverage and/or nutritional product is disclosed, along with a capsule containing same. Methods of production and use thereof are also disclosed.

### CROSS REFERENCE TO RELATED APPLICATIONS/INCORPORATION BY REFERENCE STATEMENT

This application is a US national stage application filed under 35 USC §371 of International Application No. PCT/EP2014/050260, filed Jan. 9, 2014; which claims benefit of EP Application No. 13151119.8, filed Jan. 14, 2013. The entire contents of the above-referenced applications are hereby expressly incorporated herein by reference.

### BACKGROUND

The presently disclosed and/or claimed inventive concept(s) is directed to a filter unit for a capsule for preparing a beverage and/or nutritional product. In particular, the filter unit is configured to filter a liquid that is injected into the capsule, and to deliver the filtered liquid to a separate compartment of the capsule, which holds beverage and/or nutritional products.

From the prior art a filter unit is known, which is placed inside a capsule, in order to remove contaminants from liquid injected into the capsule before the injected liquid interacts with beverage and/or nutritional ingredients. The filter unit can be designed for allowing also injection of compressed air into a compartment holding said ingredients, so that the capsule can be properly emptied after use.

Typically, the filter unit of the prior art has an upper casing and a lower casing, the two casings being assembled together. An interface between the assembled upper and lower casings can be sealed, for example ultrasonically. The filter unit further comprises a filter membrane that is connected by pinching between the upper and lower casing and/or by sealing.

For example, WO 2010/128028 A1 discloses a capsule for the preparation of a nutritional product for use in a device that is adapted to supply a liquid to the capsule. The capsule comprises a filter unit for removing contaminants contained in the injected liquid. The filter unit comprises a protective casing and at least one filter medium, in particular a filter membrane. After passing through the filter unit, the liquid is delivered to at least one compartment containing beverage ingredients. The capsule further comprises a selectively openable gas inlet, which is placed on or in the capsule to allow gas introduction from the outside into the ingredients compartment without passing through the filter unit.

WO 2010/128031 A1 discloses a capsule for the preparation of a nutritional product for use in a device that is adapted to inject a liquid to the capsule. The capsule comprises a compartment, which houses a filter unit for removing contaminants contained in the injected liquid. The filter unit comprises a microporous membrane inserted into a pressure resistant casing. The capsule further comprises a compartment for beverage ingredients. The filter unit has a filtering surface, which is smaller than the cross-section of the mouth of the ingredient compartment.

WO 2010/128051 A1 discloses a capsule for the preparation of a nutritional product in a device that is adapted to supply a liquid into the capsule. The capsule comprises a filter unit, which comprises a casing comprising a filter membrane and an outlet wall for supporting the filter membrane. The outlet wall of the filter unit comprises at least one liquid outlet, which communicates with a compartment of the capsule, in which beverage ingredients are contained.

As further prior art, WO 2009/092629 A1 discloses a capsule for use in a beverage production device, wherein the capsule is provided with an antimicrobial filter. The antimicrobial filter comprises a porous membrane.

WO 2010/112353 A1 discloses a capsule for use in a beverage production device. The capsule comprises a filter for filtering a liquid injected into the capsule, a collection member placed downstream of the filter to collect the filtered liquid, and at least one restriction orifice in the collection member to focus the flow of the liquid in at least one jet of liquid at high velocity into a compartment of the capsule, in which beverage ingredients are contained.

The interface connection between the upper casing and the lower casing needs to be absolutely tight and of sufficient tear strength, in order to resist the injection of liquid into the filter unit under relatively high pressure (several bars of pressure). Several sealing lines at the interface of such filter units are also individually formed at a filter portion and at a liquid injection portion of the filter unit, thereby providing higher risks of a defective seal. Therefore, in order to ensure the production of a safe product, drastic quality controls need to be implemented during and after the welding process and corrective adjustments of the process parameters need to be constantly implemented as well. These controls and constant corrective adjustments impact on the line performance and increase the production costs.

Further, the assembling of the filter units known from the state of the art is time consuming and requires a large number of manufacturing steps.

Another disadvantage of the state of the art filter units is that the shape is often limited (i.e. rounded) for facilitating the welding process. However, this shape is not optimal for reducing the amount of the used materials, in particular the materials for filter membranes.

The presently disclosed and/or claimed inventive concept(s) seeks to improve the state of the art by addressing the above-mentioned disadvantages. In particular, the presently disclosed and/or claimed inventive concept(s) seeks to provide a filter unit, for which the tightness, in particular the tightness to fluids under pressure, is improved and is made more reliable. The presently disclosed and/or claimed inventive concept(s) also seeks to provide a filter unit, which can be manufactured easier, at higher production speed and at lower costs.

### BRIEF DESCRIPTION OF THE DRAWINGS

In the following the presently disclosed and/or claimed inventive concept(s) will be described in more detail with reference to the attached drawings.

FIG. 1 shows an exploded view of a filter unit according to the presently disclosed and/or claimed inventive concept(s).

FIG. 2 shows an upper casing of a filter unit according to the presently disclosed and/or claimed inventive concept(s).

FIG. 3 shows a lower casing of a filter unit according to the presently disclosed and/or claimed inventive concept(s).

FIG. 4 shows the assembly of a filter unit according to the presently disclosed and/or claimed inventive concept(s).

FIG. 5 shows a perspective view of a filter unit according to the presently disclosed and/or claimed inventive concept(s).

FIG. 6 shows a cross section view through the filter unit according to the presently disclosed and/or claimed inventive concept(s).

FIG. 7 shows an enlarged cross section view of a filter unit in a capsule according to the presently disclosed and/or claimed inventive concept(s).

FIG. 8 shows two exploded views of a capsule with a filter unit according to the presently disclosed and/or claimed inventive concept(s).

FIG. 9 shows respective views of a sealed capsule with the filter unit inside according to the presently disclosed and/or claimed inventive concept(s).

### DETAILED DESCRIPTION

The presently disclosed and/or claimed inventive concept(s) seeks to improve the state of the art by addressing the above-mentioned disadvantages. In particular, the presently disclosed and/or claimed inventive concept(s) seeks to provide a filter unit, for which the tightness, in particular the tightness to fluids under pressure, is improved and is made more reliable. The presently disclosed and/or claimed inventive concept(s) also seeks to provide a filter unit, which can be manufactured easier, at higher production speed and at lower costs.

The presently disclosed and/or claimed inventive concept(s) is directed to a filter unit for a capsule for preparing a beverage and/or nutritional product, the filter unit comprising an upper casing comprising a liquid inlet, a lower casing comprising a liquid outlet, a filter provided between the upper casing and the lower casing, and a liquid delivery portion for delivering a liquid received from the liquid outlet, wherein an interface of the upper casing and the lower casing is sealed with an over-moulded ring.

The over-moulded ring ensures that the connection of the upper casing to the lower casing, i.e. an interface between the two casings, is tight and pressure resistant. The connection is in particular tight to liquid, even when liquid is injected into the filter unit under high pressure. The over-moulded ring largely reduces the likelihood of defects at the sealed interface. Furthermore, this solution also enables to organize the assembling of the filter unit in a more effective manner, in particular, by the use of a rotary cube-injection technology for which the injection of the components, their assembly and the over-moulding operation can be operated together in the same unit. As a result, the same cycle times and automation can be drastically improved over traditional assembly using (ultrasonic) welding.

The liquid delivery portion of the filter unit can deliver the filtered liquid e.g. to a compartment of a capsule containing beverage and/or nutritional ingredients. In this case the filter unit is suited to separate a position of the liquid injection into the capsule, e.g. by injector means of a beverage preparation machine, from the position of the beverage ingredients inside the capsule. The injector means do not come into contact with the ingredients. Thereby, the risk of contaminating the ingredients inside the capsule is largely reduced, and the hygiene of the produced beverage is improved.

In a particular, non-limiting embodiment, at least a part of the liquid delivery portion is formed integrally with the lower casing.

The manufacturing and in particular the assembling of the filter unit can thus be simplified and be made faster. A part of the liquid delivery portion can also be formed integrally with the upper casing, and connect to the part formed integrally with the lower casing, when the two casings are assembled.

In a particular, non-limiting embodiment, the filter comprises a filter membrane, and the over-moulded ring seals the filter membrane to the upper casing and/or lower casing in a manner to prevent a bypass of liquid. The filter unit is thus suitable for filtering liquid even at high injection pressures. The sealing of the filter membrane to the casing by the over-moulded ring ensures that all liquid injected into the capsule and delivered in the ingredient compartment is filtered.

In a particular, non-limiting embodiment, the over-moulded ring contacts (i.e., seals) a continuous annular portion of the filter membrane. Thereby, the tightness of the filter unit is made more reliable.

In a particular, non-limiting embodiment, the filter comprises a nano- or micro-porous membrane. Such a membrane, which has nano-pores or micro-pores, enables the removal of contaminants from the injected liquid.

The “contaminant” refers to microorganisms such as: bacteria, viruses, but may also encompass under certain circumstances: organic chemicals such as: acrylamide, benzene, carbofuran; inorganic chemicals such as: arsenic, cadmium, cyanide, fluoride, mercury, nitrate, nitrite; disinfectants such as: chloramines, chlorine, chlorine dioxide; disinfection byproducts such as: bromate, chlorite, haloacetic acids (HAA5), trihalomethanes (TTHMs); metals such as: zinc, silver, lead; radionuclides; organic or inorganic macro-elements such as: sand, hair or dirt; abnormal pH; and undesired odor.

In a particular, non-limiting embodiment, the filter membrane has a pore size of less than 0.4 microns, such as but not limited to, less than 0.2 microns. It may have a thickness of less than 500 microns, such as but not limited to, between 10 and 300 microns. The material of the membrane can be chosen from the list consisting of PES (polyethersulfone), cellulose acetate, cellulose nitrate, polyamide, and combinations thereof.

In a particular, non-limiting embodiment, the filter comprises a support grid for the filter membrane. The support grid ensures that the filter membrane is not damaged during use, even when liquid is injected under high pressures into the filter unit.

In a particular, non-limiting embodiment, the support grid is clipped into the lower casing. This enables to easily and quickly provide a lower sub-assembly before over-moulding operation.

In a particular, non-limiting embodiment, the upper casing, the lower casing and the filter form a filter portion, and the over-moulded ring forms an integral piece that seals both the filter portion and the liquid delivery portion. In a particular, non-limiting embodiment, the over-moulded ring forms two closed loops for individually sealing the filter portion and the liquid delivery portion, respectively, the two closed loops being integrally linked. Therefore, the integral over-moulded ring ensures a connection of the different key portions of the casing all at once that simplifies the manufacturing of the filter unit.

In a particular, non-limiting embodiment, the liquid delivery portion is arranged side-by-side with the filter portion. When the filter unit is inserted into a capsule, the liquid delivery portion can thus deliver the liquid filtered by the filter portion to an ingredient compartment of the capsule. The two closed loops ensure an optimal sealing of all portions of the filter unit.

In a particular, non-limiting embodiment, the over-moulded ring covers the outer surface of the filter portion at least from an upper surface of the upper casing to a part on the lower casing below the interface.

In a particular, non-limiting embodiment, the upper casing and the lower casing are provided with connection means for clipping the two casings together. The connection means allow a simple attachment of the upper casing to the lower casing. Simple clipping is sufficient, since the initial connection of the upper casing to the lower casing (i.e., before over-moulding) does not need to be tight. The tightness is provided by the over-moulded ring.

In a particular, non-limiting embodiment, the filter unit further comprises an air inlet that is separate from the liquid inlet and, in a particular, non-limiting embodiment, is formed integrally with the upper casing. The air inlet, in a particular non-limiting embodiment, communicates by a conduit directly with the liquid delivery portion without passing through the filter.

Through the air inlet, pressurized air can be injected into a capsule, in which the filter unit is installed. The injected air bypasses the filter membrane due to the direct communication of the air inlet with the delivery portion. The injected air ensures that the capsule is emptied completely of liquid after use, i.e. after the beverage has been produced by the interaction of liquid and ingredients.

In a particular, non-limiting embodiment, the upper casing and/or the lower casing have a rectangular or square seat for lodging a filter having a complementary shape. Consequently, the filter membrane can be of square or rectangular shape, which is an optimal shape for material saving.

The presently disclosed and/or claimed inventive concept(s) is further directed to a capsule for preparing a beverage and/or nutritional product, the capsule comprising a filter unit according to the description above.

The capsule employs all the above-described advantages of the filter unit. The capsule can in particular be used for hygiene sensitive beverage and/or nutritional ingredients such as infant formula, because the contaminants can be removed from the liquid provided in the capsule before mixing with the ingredients and because the ingredient compartment is maintained separated from the liquid injection site by the filter unit thus preventing any risk of contamination by the external injection means of the beverage and/or nutritional production device.

In a particular, non-limiting embodiment, the capsule comprises a compartment containing beverage and/or nutritional ingredients, and a dedicated seat for receiving the filter unit such that the liquid delivery portion is arranged for delivering a liquid into the compartment.

The liquid delivery portion thus acts as a means which is internal to the capsule for injecting liquid into the compartment containing the ingredients. The liquid delivery portion can be designed with a specific outlet or nozzle such that the liquid is injected into the ingredient compartment as one or more liquid jets or as a spray of liquid. The liquid delivery portion can be designed differently for different ingredients to be filled in a capsule. In particular, the liquid delivery portion can be designed for each type of ingredients for achieving the optimal dissolution of the ingredients.

The presently disclosed and/or claimed inventive concept(s) is further directed to a manufacturing method for a filter unit for a capsule for preparing a beverage and/or nutritional product, the method comprising the steps of: (1) assembling an upper casing and a lower casing with a filter inserted between the casings; and (2) over-moulding a sealing ring to seal the interface between the upper casing and the lower casing.

The method further comprises providing a filter membrane and sealing the filter membrane to the upper casing and/or lower casing by the over-moulded sealing ring so that the bypass of the filter by liquid is prevented.

The method further comprises maintaining the filter membrane by vacuum in the upper casing or lower casing during assembly.

The manufacturing method is simpler and faster than methods for manufacturing comparable filter units of the state of the art. Further, the manufacturing method can be carried out at lower costs.

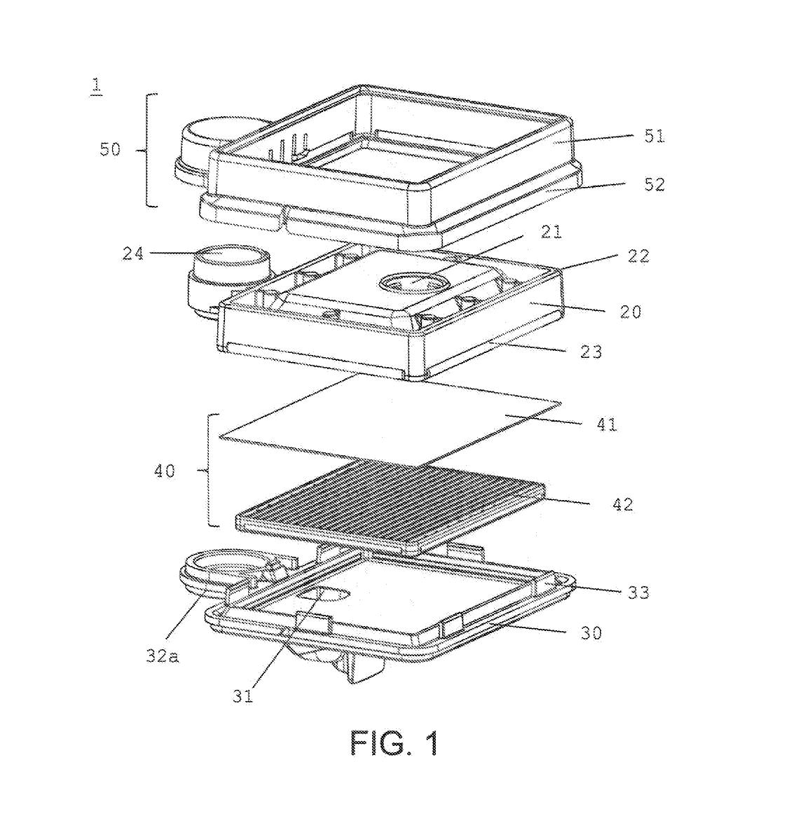

In FIG. 1 the parts of the filter unit 1 of the presently disclosed and/or claimed inventive concept(s) are shown in an exploded view, i.e. before assembly of the filter unit 1. The filter unit 1 comprises an upper casing 20 and a lower casing 30. The upper casing 20 can be assembled with the lower casing 30, i.e. can be attached to the lower casing 30. In between the two casings 20 and 30 a filter 40 is included. The upper casing 20, the lower casing 30 and the filter 40 form a filter portion of the filter unit 1. The filter portion has a general transversal cross section or shape of a square or rectangle in the illustrated (but non-limiting) mode.

The upper casing 20 has a liquid inlet 21, and the lower casing 30 has a liquid outlet 31, so that a liquid injected into the filter unit 1 can flow from the liquid inlet 21, through the filter 40, and to the liquid outlet 31. The filter 40 is designed to filter contaminants from the injected liquid. In a particular, non-limiting embodiment, the filtering function is provided by a filter membrane 41, which is (for example, but not by way of limitation) a nano- or micro-porous membrane. However, other filter media are also possible. In a particular, non-limiting embodiment, the upper casing 20 and the lower casing 30 are made of a plastic material.

The filter unit 1 is further provided with a liquid delivery portion 32, which is adapted to receive the filtered liquid that exits the liquid outlet 31. The liquid delivery portion 32 is adapted to deliver the filtered liquid away from the filter unit 1. For example, the filtered liquid can be delivered into an ingredient compartment of a capsule, into which the filter unit 1 is installed.

The filter unit 1 finally comprises an over-moulded sealing ring 50, which is provided to an interface or junction line 25 formed between the assembled upper casing 20 and lower casing 30. The interface 25 is formed by the contacting surfaces of the two casings 20 and 30 when connected to each other. The over-moulded ring 50 is adapted to seal the interface along its complete circumference in a way that no liquid can exit from or enter into the inside of the filter unit 1. The over-moulded ring 50 thus completely surrounds the filter portion. In a particular, non-limiting embodiment, the over-moulded ring 50 is produced by over-moulding the casings 20, 30 with a mouldable, liquid-tight and pressure-resistant material such as a thermoplastic elastomer or resin material (such as polypropylene).

In a particular, non-limiting embodiment, the liquid delivery portion 32 is formed by the assembly of the lower casing 30 and upper casing 20. A lower part of the delivery portion 32 is formed by the lower casing 30. An upper part of the liquid delivery portion 32 is formed by the upper casing 20. As for example shown in FIG. 1, the liquid delivery portion 32 extends from below the filter portion to a side adjacent the filter portion thus enabling to position the filter unit in an off-centered manner in the capsule. In FIG. 1 the upper casing 20 is integrally formed with an air inlet 24, which connects to the liquid outlet part 32a of the liquid delivery portion 32, when the two casings 20 and 30 are assembled.

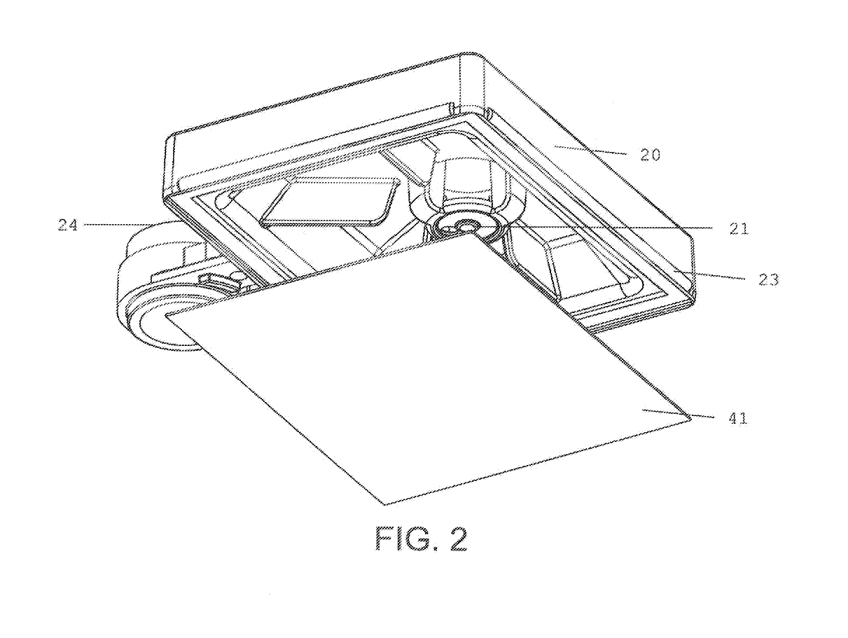

FIG. 2 shows the upper casing 20 and the filter membrane 41 of the filter 40. In a particular, non-limiting embodiment, the upper casing 20 has a rectangular or square shape seat for receiving and lodging the filter membrane 41. The filter membrane 41 has (in a particular, non-limiting embodiment) a complementary rectangular or square shape. During assembly of the filter unit 1, the filter membrane 41 is held in the upper casing 30 by vacuum. The vacuum can for example be drawn through the liquid inlet 21.

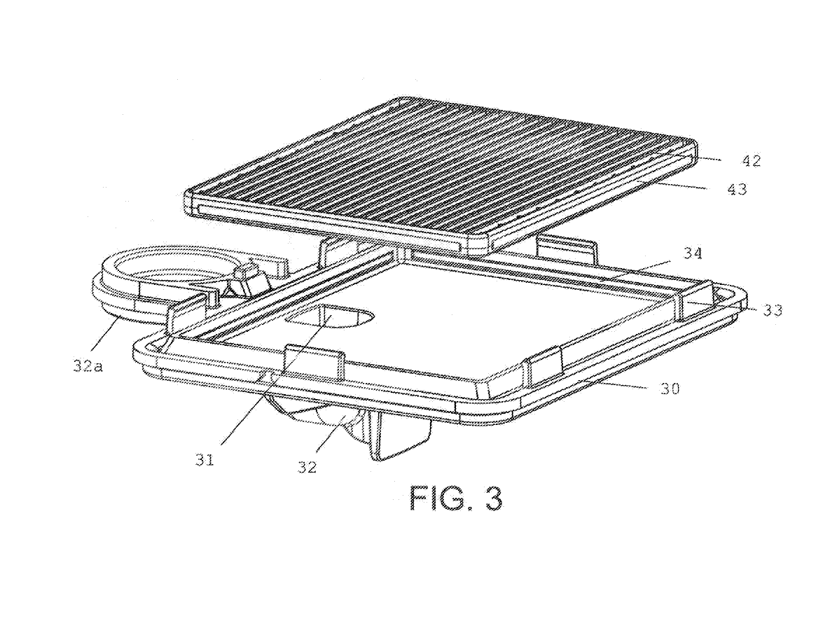

FIG. 3 shows the lower casing 30 and a support grid 42 for the filter membrane 41, which is part of the filter 40. In a particular, non-limiting embodiment, the lower casing 30 comprises a square or rectangular shaped seat for receiving the support grid 42. In a particular, non-limiting embodiment, the support grid 42 has a complementary rectangular or square shape. The support grid is (in a particular, non-limiting embodiment) made of a plastic material or a metal material, e.g. aluminum. The support grid 42 is (in a particular, non-limiting embodiment) attached to the lower casing 30 by clipping or clamping. Therefore, the support grid 42 is provided with clipping means 43, which are (in a particular, non-limiting embodiment) ably provided on its peripheral or side surface. The clipping means 43 can, for example, be designed in the form of at least one ridge 43 that is provided continuously or discontinuously around the side surface of the support grid 42. The lower casing 30 is provided with corresponding clipping means 34, for example, designed in the form of at least one groove 34, which is adapted to receive the ridges 43 formed on the support grid 42. Thus, the support grid 42 can be easily clipped into the seat of the lower casing 30, namely by pressing onto the support grid 42 until the at least one ridge 43 snaps into the at least one groove 34.

In FIG. 3 can further be seen that liquid, which exits from the liquid outlet 31 of the filter portion, enters the liquid delivery portion 32. The liquid delivery portion 32 is adapted to transfer the liquid to a liquid outlet structure 32a, which is (in a particular, non-limiting embodiment) arranged side-by-side with the lower casing 30. Side-by-side means in this case that the liquid outlet structure 32a is arranged substantially in plane with the lower casing 30, said plane being (in a particular, non-limiting embodiment) parallel to the surface of the filter 40.

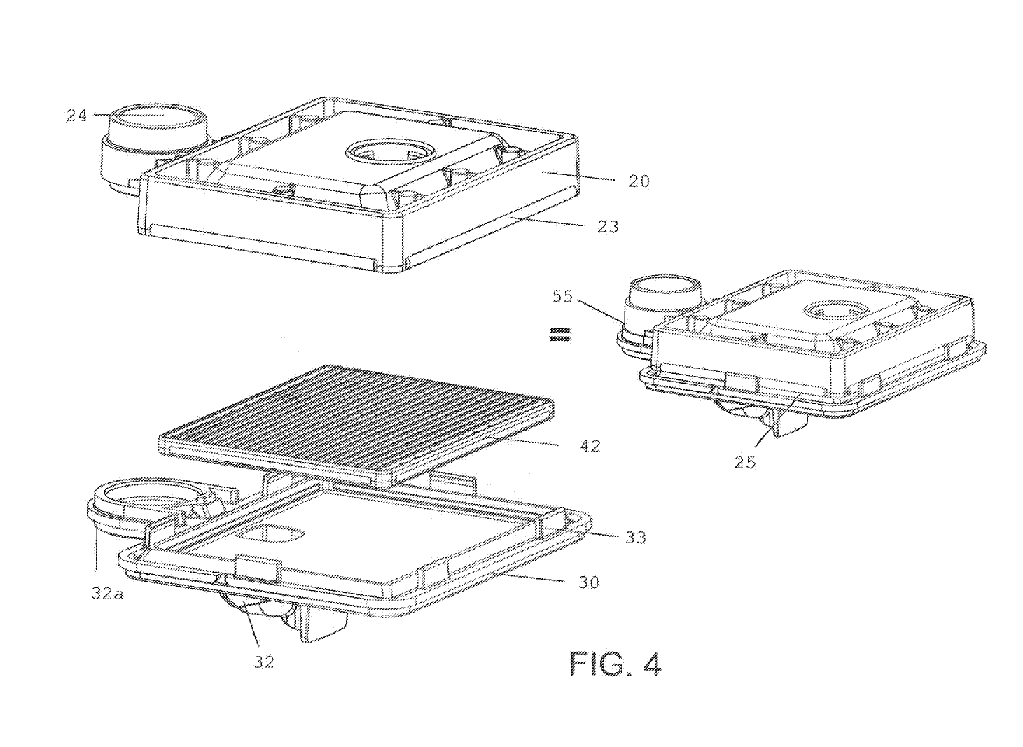

FIG. 4 shows how the upper casing 20, in which the filter membrane 41 is held by vacuum, is assembled with the lower casing 30, which contains the support grid 42. The upper and lower casings 20 and 30 are (in a particular, non-limiting embodiment) provided with connection means 23 and 33, respectively, for clipping the two casings 20 and 30 together. In a particular, non-limiting embodiment, the connection means 23 on the upper casing 20 are designed as ridges 23, which are provided on the side surface of the upper casing 20. The connection means 33 of the lower casing 30 are (in a particular, non-limiting embodiment) designed as hooks 33, which are provided on the outer periphery of the lower casing 30. The connection means 23 and 33 are designed such that when the lower casing 30 and the upper casing 20 are pressed together, the hooks 33 snap around the ridges 23. Of course, in an alternative, the casings 20, 30 can bear the hooks and ridges in a reverse configuration. After assembly, the filter membrane 41 and the support grid 42 contact each other or are sufficiently close to each other, so that the filter membrane 41 is supported by the support grid 42 at rest, or at least when liquid is injected under pressure in the filter unit through the inlet 21.

On the right side of FIG. 4 is shown how the filter unit 1 looks after assembling the two casings 20 and 30 together, but before the over-moulding step. An interface 25 of the surfaces, with which the upper casing 20 and the lower casing 30 connect to each other, is formed around the periphery of the filter portion of the filter unit 1. Further, in the embodiment shown in FIG. 4, the liquid delivery portion 32, in particular the liquid outlet structure 32a, connects with the air inlet 24 of the upper casing 20. The liquid delivery portion 32 and the air inlet 24 can be respectively provided with connection means (not shown), which can be designed similar to the connection means 23 and 33 of the filter portion of the filter unit 1. However, the air inlet 24 and the liquid delivery portion 32 can also be designed without connection means, and are in this case simply connected to each other by the attachment of the upper casing 20 to the lower casing 30.

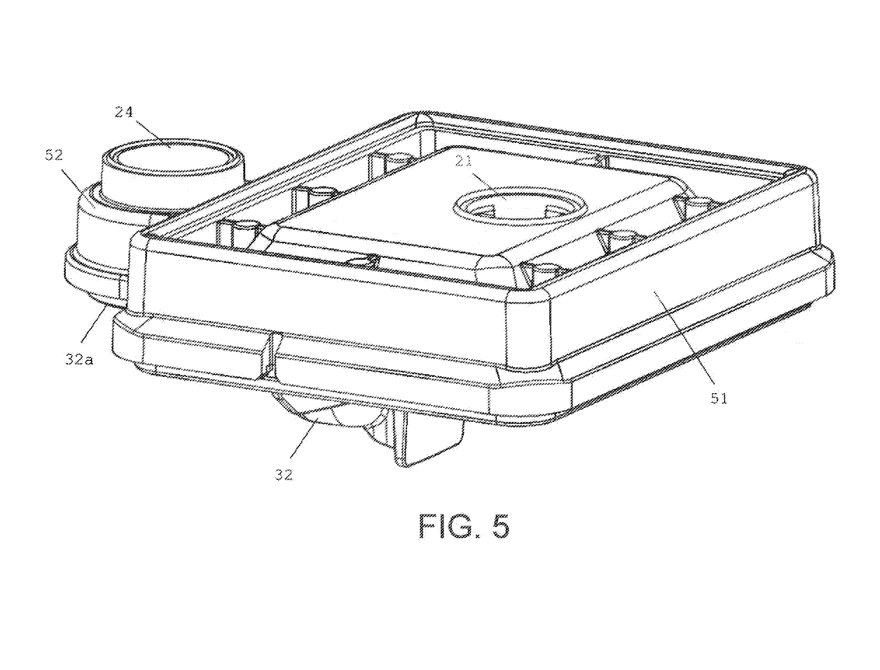

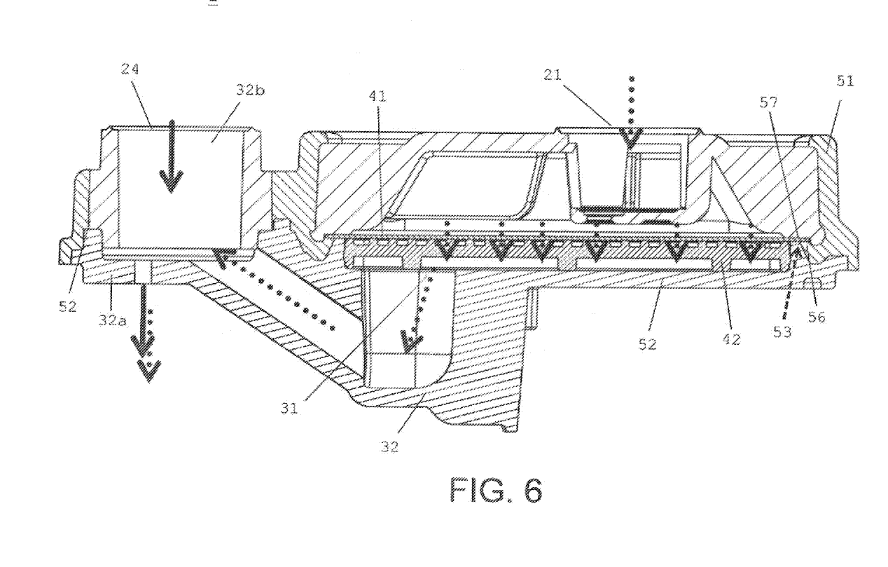

FIGS. 5 and 6 show the filter unit 1 after over-moulding. The over-moulded ring 50 is provided around the filter portion of the filter unit 1, in order to seal the peripheral interface 25 shown in FIG. 4 between the upper casing 20 and the lower casing 30. The filter membrane 41 is thereby sealed inside the filter portion of the filter unit 1, i.e. between the two casings 20 and 30. The filter membrane 41 is sealed in a way that liquid injected into the liquid inlet 21 has to flow through the filter 40, but cannot bypass the filter 40.

The over-moulded ring 50 (in a particular, non-limiting embodiment) comprises two closed loops, which form an integral piece that seals both the filter portion and the liquid delivery portion 32 of the filter unit 1. In a particular, non-limiting embodiment, a first closed loop 51 seals the filter portion of the filter unit 1 along the peripheral interface 25. A second closed loop 52 individually seals the liquid delivery portion 32, in particular a peripheral or circumferential interface 55 between the liquid outlet structure 32a and the air inlet 24. The two closed loops 51 and 52 are integrally linked. As shown further in FIG. 5, the over-moulded ring 50 (in a particular, non-limiting embodiment) covers at least the outer surface of the upper casing 20, and in a more particular, non-limiting embodiment, even an upper surface of the upper casing 20, and may reach (in a non-limiting embodiment) as far down on the outer surface of the lower casing 30 so that it covers at least a part of the lower casing below the interface 25.

The over-moulded ring 50 provides impermeability for liquids injected into the filter portion of the filter unit 1 and liquid flowing through the delivery portion 32 of the filter unit 1, respectively. The tightness provided by the over-moulded ring 50 is able to withstand even liquid injected into the filter unit 1 with high pressure. The over-moulded ring 50 seals the filter portion and the delivery portion 32 to the outside. Thus, no liquid can exit at the connection of the upper casing 20 and the lower casing 30. Further, no contamination can enter from the outside into the interior of the unit. The over-moulding step for creating the over-moulded ring 50 can be integrated in a cost and time performing production line such as a line using a cube-injection technology in which the injection of the components, assembly operations including the filter in the casings and the over-moulding of the ring, as described earlier, are performed in a cube-injection unit. As a result, the cycle times can be significantly reduced compared to conventional assembly and welding operations.

FIG. 6 shows a cross-section through the filter unit 1 of the presently disclosed and/or claimed inventive concept(s). In particular, FIG. 6 shows how liquid is guided through the filter unit 1. The liquid is (in a particular, non-limiting embodiment) injected through the liquid inlet 21. The liquid then passes the filter 40 comprising the filter membrane 41 and the support grid 42. The over-moulded ring 50, in particular the loop 51 of the over-moulded ring, contacts (in a particular, non-limiting embodiment) an annular portion of the filter membrane 41 at its periphery, so that the filter membrane 41 becomes sealed to the casing and a bypass of the injected liquid is prevented. In particular, a peripheral gap is left between the upper casing 20 and lower casing 30 which is filled by the material of the over-moulded ring 50. The filled gap can form at least one continuous circumferential lip 56 of sealing material which engages with a continuous circumferential portion 57 of the filter. The contact area is represented on the lower side of the filter membrane but a contact on the upper side or on both sides is also possible.

During operation of the filter unit, after passing through the filter 40, the liquid flows out of the liquid outlet 31 of the lower casing 30, and into the liquid delivery portion 32. As can be seen in FIG. 6, the liquid delivery portion 32 guides the liquid into a chamber 32b that is provided side-by-side with the filter unit 1. The chamber 32b forms a sufficient room for the introduction of an external air injection means (e.g., probe) through the air inlet portion 24. The liquid outlet structure 32a and the air inlet portion 24 are sealed at their circumferential interface 55 by the loop 52 of the over-moulded ring 50.

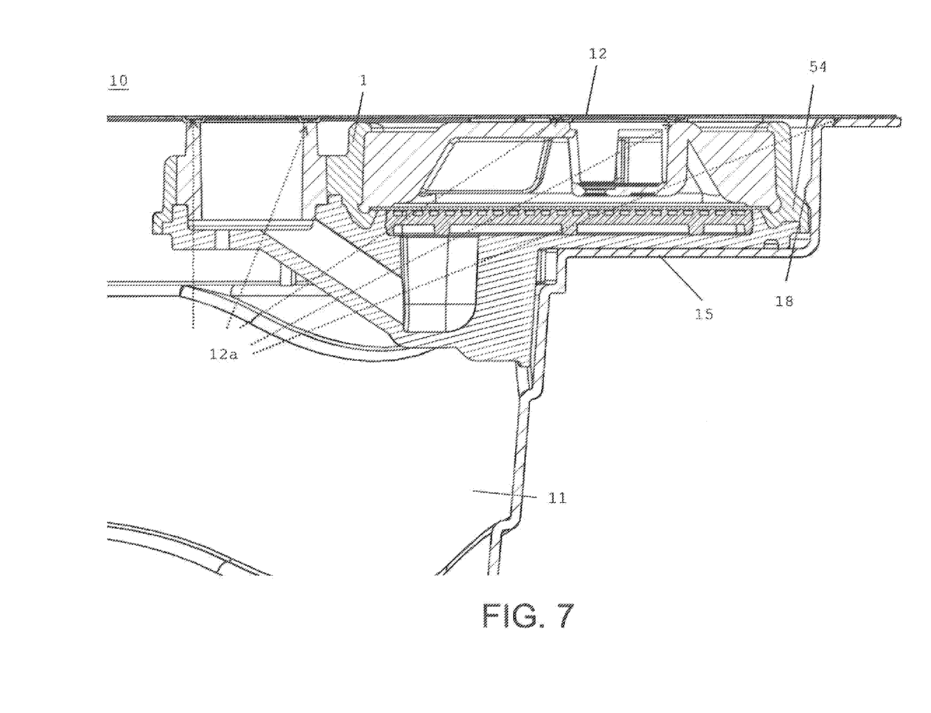

FIG. 7 shows the filter unit 1 inserted into a capsule 10 according to the presently disclosed and/or claimed inventive concept(s). The capsule 10 comprises a seat 15 for receiving the filter unit 1. The seat 15 is (in a particular, non-limiting embodiment) provided side-by-side with a compartment 11 of the capsule 10, which is designed for holding beverage and/or nutritional ingredients. For example, the ingredients are an infant formula in powder form. In a particular, non-limiting embodiment, the compartment 11 and the seat 15 holding the filter unit 1 are closed off with a single upper membrane 12 of the capsule 10. The upper membrane 12 can be welded at welding lines 12a, in particular to the seat 15 and/or to the filter unit 1. The filter unit 1 is (in a particular, non-limiting embodiment) clipped into the seat 15, whereby the over-moulded ring 50 is (in a particular, non-limiting embodiment) designed such that it integrally forms connection means 54 on its outer surface. These connection means 54 connect to connecting means 18 of the seat 15 of the capsule 10. In a particular, non-limiting embodiment, the connection means 54 on the side surface of the over-moulded ring 50 are provided in the form of at least one ridge 54, which can be pushed below a ridge 18 provided on the inner surface of the seat 15, in order to provide a snap connection.

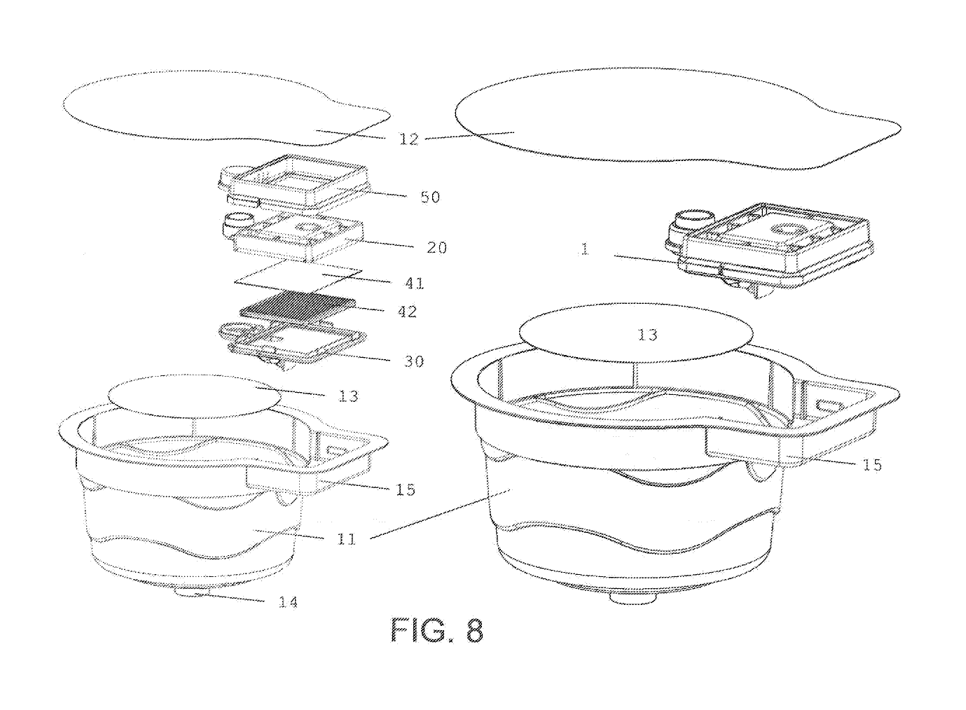

FIG. 8 shows the capsule 10 and the filter unit 1 in exploded views. The seat 15 has (in a particular, non-limiting embodiment) a square or rectangular shape, which matches the square or rectangular shape of the filter portion on the filter unit 1. The seat 15 is provided side-by-side with a mouth of the compartment 11 for holding the beverage and/or nutritional ingredients. When the filter unit 1 is clipped into the seat 15, the liquid delivery portion 32 is arranged such that the liquid outlet structure 32a is positioned for injecting liquid into the compartment 11 holding the ingredients. The liquid delivery portion 32 can be designed such that it forms a liquid jet for injection into the compartment 11, or that it forms a liquid spray for injection into the compartment 11. At least one liquid jet can for example be achieved by providing the outlet structure with at least one small outlet hole having (in a particular, non-limiting embodiment) a diameter of 0.1 to 2 mm, such as but not limited to, 0.1 to 1 mm. Liquid spray can be achieved for example with many outlet holes, and in a particular, non-limiting embodiment, of a diameter between 0.5 and 3 mm, such as but not limited to, 1 to 2 mm. The capsule 10 is closed off with a lower membrane 13 on its lower side, where the capsule 10 is also provided with a liquid outlet 14. Further, the capsule top side is closed off with the upper membrane 12, which (in a particular, non-limiting embodiment) covers in one integral piece the mouth of the compartment 11 and the seat 15, which holds the filter unit 1. Both membranes 12 and 13 are (in a particular, non-limiting embodiment) made of a thin metal sheet, for example aluminum. The positions of the liquid inlet 16 and air inlet 17 are apparent as defined by the welding lines 12a onto the compartment, seat and filter unit.

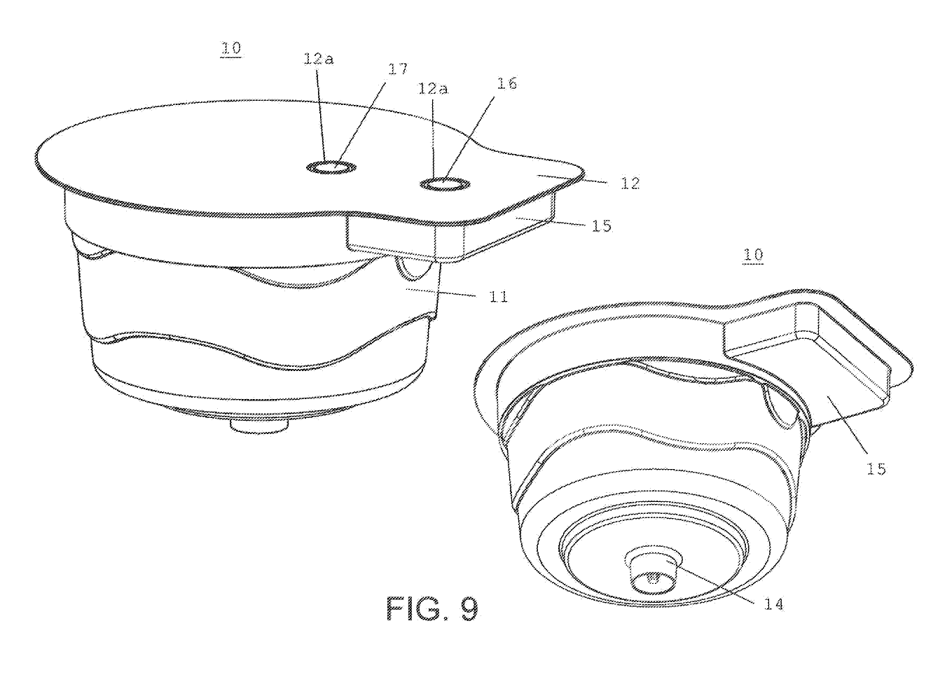

FIG. 9 shows the capsule 10 in closed state. The upper membrane 12 seals the compartment and filter unit all at once. The upper membrane can be pierced by liquid injection means of a beverage preparation machine to form a liquid inlet 16 arranged right above the liquid inlet 21 of the filter unit 1. The upper membrane 12 can be pierced further by air injection means of the same beverage preparation machine at another position to form an air inlet 17, which is arranged right above the air inlet 24 of the filter unit 1. The liquid inlet 16 and the air inlet 17 can be preformed.

When liquid is injected into the capsule 10, it is filtered by the filter unit 1, and is provided as at least one liquid jet or a liquid spray to the compartment 11 of the capsule 10. Thereby, a hygienic solution is provided. Providing additionally injected air to the capsule 10 can support the formation of a liquid jet, and can ensure that the capsule 10 is emptied completely after use. The liquid delivery unit 32 of the filter unit 1 is (in a particular, non-limiting embodiment) designed such that the beverage and/or nutritional ingredients in the compartment 11 are properly dissolved. Therefore, for different beverage and/or nutritional ingredients the liquid delivery portion 32 can be designed differently. For example, for some ingredients a liquid jet is optimal for dissolving the ingredients, whereas for other ingredients a liquid spray is optimal. Therefore, the liquid outlet structure 32a can be varied in its diameter or shape, or several outlet holes can compose the liquid outlet structure 32a.

The prepared beverage can leave the capsule 10 via the outlet 14. The outlet 14 can further comprise means for redirecting the beverage, or for foaming the beverage.

In summary, the presently disclosed and/or claimed inventive concept(s) provides a filter unit 1 and a capsule 10 for receiving the filter unit 1. The filter unit filters a liquid that is injected into the capsule 10, before it further provides the filtered liquid to beverage ingredients housed inside the capsule 10. Therefore, the filter unit 1 is composed of an upper casing 20 and a lower casing 30, with a filter 40 disposed in between. Further, the filter unit 1 is provided with a liquid delivery portion 32 for delivering the liquid from a liquid outlet 31 of the lower casing 30 into the compartment 11 of the capsule 10. The presently disclosed and/or claimed inventive concept(s) ensures that injector means of a beverage preparation machine never touch the beverage ingredients inside the capsule 10. Further, the contaminants from the injected liquid can be filtered. Finally, the liquid injected into the compartment 11 can be formed, for example as liquid jet or liquid spray. Therefore, the filter unit and the capsule 10 of the presently disclosed and/or claimed inventive concept(s) achieve a significant improvement over the state of the art.

1. A filter unit for a capsule for preparing a beverage and/or nutritional product, the filter unit comprising:
an upper casing comprising a liquid inlet;
a lower casing comprising a liquid outlet;
a filter provided between the upper casing and the lower casing; and
a liquid delivery portion for delivering a liquid received from the liquid outlet; and
wherein an interface of the upper casing and the lower casing is liquid-tightly sealed with an over-moulded ring.

2. The filter unit according to claim 1, wherein at least a part of the liquid delivery portion is formed integrally with the lower casing.

3. The filter unit according to claim 1, wherein the filter comprises a filter membrane, and the over-moulded ring seals the filter membrane to the upper casing and/or lower casing to prevent a bypass of liquid.

4. The filter unit according to claim 3, wherein the over-moulded ring contacts a continuous annular portion of the filter membrane.

5. The filter unit according to claim 1, wherein the filter comprises a nano- or micro-porous membrane.

6. The filter unit according to claim 1, wherein the filter comprises a support grid for the filter membrane clipped into the lower casing.

7. The filter unit according to claim 1, wherein the upper casing, the lower casing, and the filter form a filter portion, and the over-moulded ring is an integral piece that seals both the filter portion and the liquid delivery portion.

8. The filter unit according to claim 7, wherein the over-moulded ring forms two closed loops for individually sealing the filter portion and the liquid delivery portion, respectively, the two closed loops being integrally linked.

9. The filter unit according to claim 1, wherein the over-moulded ring covers an outer surface of the filter portion at least from an upper surface of the upper casing to a part on the lower casing below the interface.

10. The filter unit according to claim 1, wherein the upper casing and the lower casing are provided with connection means for clipping the two casings together.

11. The filter unit according to claim 1, further comprising an air inlet that is separate from the liquid inlet and is formed integrally with the upper casing.

12. The filter unit according to claim 1, wherein the upper casing and/or the lower casing have a rectangular or square seat for lodging the filter having a complementary shape.

13. A capsule for preparing a beverage and/or nutritional product, the capsule comprising a filter unit according to claim 1.

14. The capsule according to claim 13, further comprising:
a compartment for beverage and/or nutritional ingredients; and
a seat for receiving the filter unit such that the liquid delivery portion is arranged for delivering a liquid into the compartment.

15. A manufacturing method for a filter unit for a capsule for preparing a beverage and/or nutritional product, the method comprising the steps of:
assembling an upper casing and a lower casing with a filter inserted between the casings; and
over-moulding a sealing ring to seal the interface between the upper casing and the lower casing.
